(19) United States
(12) Patent Application Publication
(10) Pub. No.: US 2007/0068740 A1
(43) Pub. Date: Mar. 29, 2007

(54) Fluid supply hose coupling structure for a materials handling vehicle

(76) Inventors: David Langenkamp, Carmel, IN (US); Nathan Leroy Blake, Coldwater, OH (US)

Correspondence Address: STEVENS & SHOWALTER LLP, 7019 CORPORATE WAY, DAYTON, OH, 45459-4238, US

(21) Appl. No.: 11/236,081

(22) Filed: Sep. 27, 2005

(51) Int. Cl. B66F 9/22

(52) U.S. Cl. 187/234

(57) ABSTRACT

A materials handling vehicle is provided comprising a base, a movable carriage assembly, and a ram/cylinder assembly coupled to the carriage assembly to effect movement of the carriage assembly. The ram/cylinder assembly comprises a cylinder having an opening in a side wall for receiving a fluid, a ram disposed in the cylinder and coupling structure connected to the cylinder side wall including a bore communicating with the cylinder side wall opening. Further provided is a fluid supply system including a fluid hose connected to the coupling structure for supplying pressurized fluid to the coupling structure to effect movement of the ram in the cylinder such that movement of the ram causes movement of the carriage assembly.

### CROSS REFERENCE TO RELATED APPLICATION

The present application is related to U.S. patent application Ser. No. ______, Attorney Docket CRN424PA, entitled “PULLEY ASSEMBLY FOR A MATERIALS HANDLING VEHICLE MAST ASSEMBLY,” which is filed concurrently herewith and hereby incorporated by reference herein.

### TECHNICAL FIELD

The present invention relates to a materials handling vehicle comprising a movable element and a ram/cylinder assembly for effecting movement of the movable element, wherein the ram/cylinder assembly comprises a cylinder having a sidewall to which a fluid supply hose is mounted via coupling structure connected to the cylinder sidewall.

### BACKGROUND OF THE INVENTION

Materials handling vehicles are known in the prior art comprising a base unit including a power source and a mast assembly. A fork carriage assembly is coupled to the mast assembly for vertical movement relative to the mast assembly. A cylinder assembly is coupled to the fork carriage and the mast assembly for effecting the vertical movement of the carriage assembly relative to the mast assembly. A hydraulic fluid supply system is coupled to the cylinder assembly for supplying a pressurized fluid to the cylinder assembly.

The cylinder assembly comprises a ram/cylinder unit. Pressurized hydraulic fluid is provided to a base of a cylinder of the ram/cylinder unit such that the fluid applies a pressure to a surface of the ram facing the cylinder base. A flow control valve may be provided in the cylinder base.

Typically, the cylinder is coupled to a bracket positioned in a lower portion of a weldment forming part of the mast assembly. The weldment includes a lower brace or other reinforcement structure making access to the base of the cylinder difficult. As noted above, hydraulic fluid is provided to the base of the cylinder. A first supply hose is coupled to a first fitting, which, in turn, is coupled to a second supply hose. The second supply hose is metal and is also coupled to a second fitting, which, in turn, is coupled to the cylinder base. Because of the reinforcement structure provided in the lower portion of the weldment and due to the fork carriage being located near the weldment lower portion when the carriage is in its home position, access to the base of the cylinder is difficult. Accordingly, connection of at least the second supply hose and the second fitting to one another and the cylinder base is difficult during vehicle assembly in manufacturing or servicing in the field. It is also noted that a separate bracket is required to anchor the first supply hose to the lower portion of the weldment.

A further arrangement for supplying hydraulic fluid to a fork carriage assembly lift cylinder is desired.

### SUMMARY OF THE INVENTION

In accordance with a first aspect of the present invention, a materials handling vehicle is provided comprising a base, a movable element and a ram/cylinder assembly coupled to the movable element to effect movement of the element. The ram/cylinder assembly comprises a cylinder having an opening in a side wall for receiving a fluid, a ram disposed in the cylinder and coupling structure connected to the cylinder side wall including a bore communicating with the cylinder side wall opening. Further provided is a fluid supply system including a fluid hose connected to the coupling structure for supplying pressurized fluid to the coupling structure to effect movement of the ram in the cylinder, wherein movement of the ram causes movement of the movable element.

The coupling structure may be positioned on the cylinder side wall at a location above a base of the ram.

The ram/cylinder assembly may be coupled to a mast weldment having first and second vertical frame members and upper and lower braces. The coupling structure may be positioned on the cylinder side wall at a location above the mast weldment lower brace.

A base of the cylinder may be supported by a bracket coupled to the lower brace.

The coupling structure may comprise a collar connected to the cylinder side wall, wherein the collar includes a bore communicating with the cylinder side wall opening.

A flow control valve may be provided in the bore in the collar. The collar may have sufficient rigidity to function as an anchor block for the fluid hose.

The movable element may comprise a movable carriage assembly. The carriage assembly may comprise a fork carriage assembly. The movable element may also comprise a movable weldment of a mast assembly, a platform or like apparatus.

The ram/cylinder assembly may further comprise a seal coupled to the ram or an inner wall of the cylinder.

In accordance with a second aspect of the present invention, a materials handling vehicle is provided comprising a base; a mast assembly coupled to the base; a fork carriage assembly coupled and movable relative to the mast assembly; and a ram/cylinder assembly coupled to the fork carriage assembly and the mast assembly to effect movement of the fork carriage assembly relative to the mast assembly. The ram/cylinder assembly may comprise a cylinder having an opening in a side wall for receiving a fluid, a ram disposed in the cylinder and coupling structure connected to the cylinder side wall. The coupling structure may include a bore communicating with the cylinder side wall opening. Further provided is a fluid supply system including a fluid hose connected to the coupling structure for supplying pressurized fluid to the coupling structure to effect movement of the ram in the cylinder such that movement of the ram causes movement of the fork carriage assembly.

The coupling structure may comprise a collar connected to the cylinder side wall, wherein the collar includes a bore communicating with the cylinder side wall opening.

The mast assembly may comprise an outer weldment coupled to the base; an intermediate weldment capable of moving in a direction away from the base such that a lower end of the intermediate weldment is positioned adjacent an upper end of the outer weldment; and an inner weldment capable of moving in a direction away from the base such that a lower end of the inner weldment is positioned adjacent an upper end of the intermediate weldment. The intermediate weldment includes at least one guide element mounted adjacent its upper end. The fork carriage assembly is coupled to the inner weldment so as to move with the inner weldment. The collar is preferably connected to the cylinder at a location such that the collar does not engage the intermediate weldment guide element when the inner weldment is moved to a position where its lower end is positioned adjacent the upper end of the intermediate weldment.

### BRIEF DESCRIPTION OF THE DRAWINGS

FIG. 1 is a perspective view of a truck including a fork carriage assembly lift unit of the present invention;

FIG. 2 is front perspective view of a mast assembly, a fork carriage assembly and a fork carriage assembly lift unit forming part of the truck of FIG. 1;

FIG. 3 is a rear perspective view of the mast assembly and fork carriage assembly lift unit of FIG. 1, with the fork carriage assembly removed;

FIG. 4 is a partially exploded view of a ram/cylinder assembly of the fork carriage assembly lift unit of FIG. 1:

FIG. 5 is a cross-sectional view of the ram/cylinder assembly of FIG. 4:

FIG. 6 is a front view of a portion of the mast assembly and the ram/cylinder assembly of the fork carriage assembly lift unit with the fork carriage assembly not shown;

FIG. 7 is a rear view partially in section of a portion of the mast assembly and the ram/cylinder assembly with a controller, a hydraulic motor/pump assembly, and a manifold forming part of the fork carriage assembly lift unit shown in schematic form;

FIG. 7A is a top view of the collar illustrated in FIG. 7;

FIG. 8 is a perspective view of the first, second and third weldments of the mast assembly expanded;

FIG. 9 is a partial view of the second and third weldments of the mast assembly, when those weldments are extended;

FIG. 10 is a partial perspective view of a mast assembly constructed in accordance with a second embodiment of the present invention; and

FIG. 11 is a cross-sectional view of a ram/cylinder assembly of an alternative embodiment of the present invention.

### DETAILED DESCRIPTION OF THE INVENTION

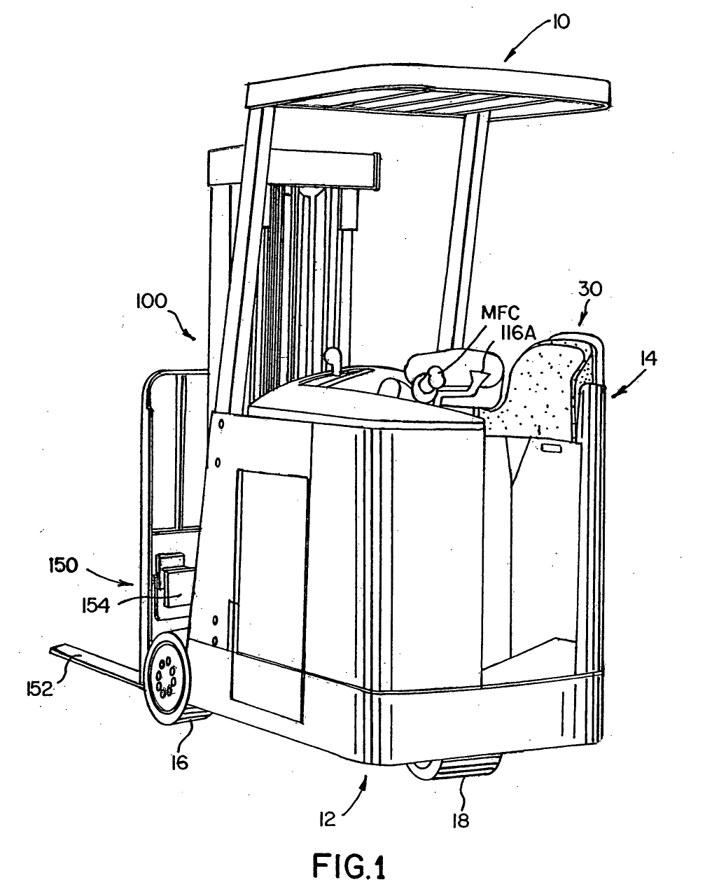

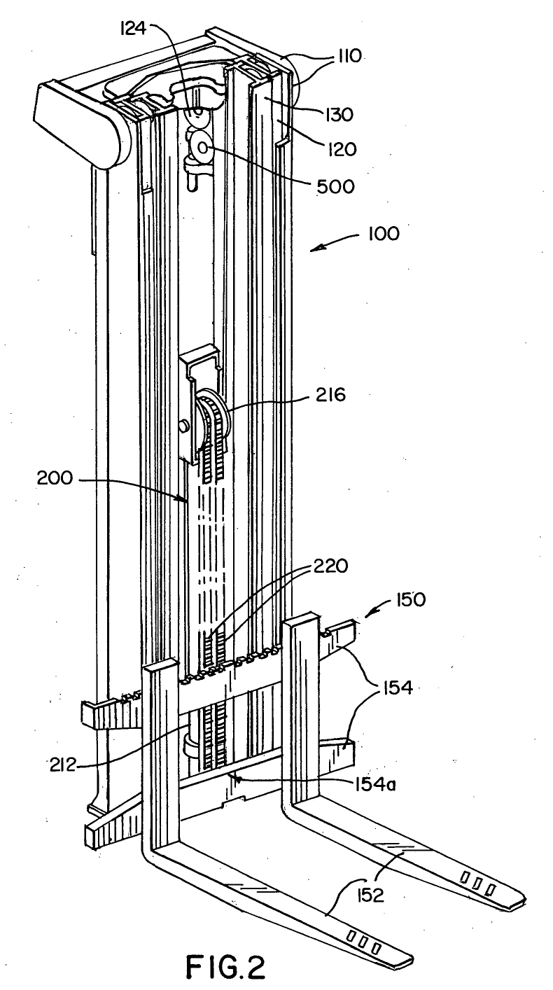

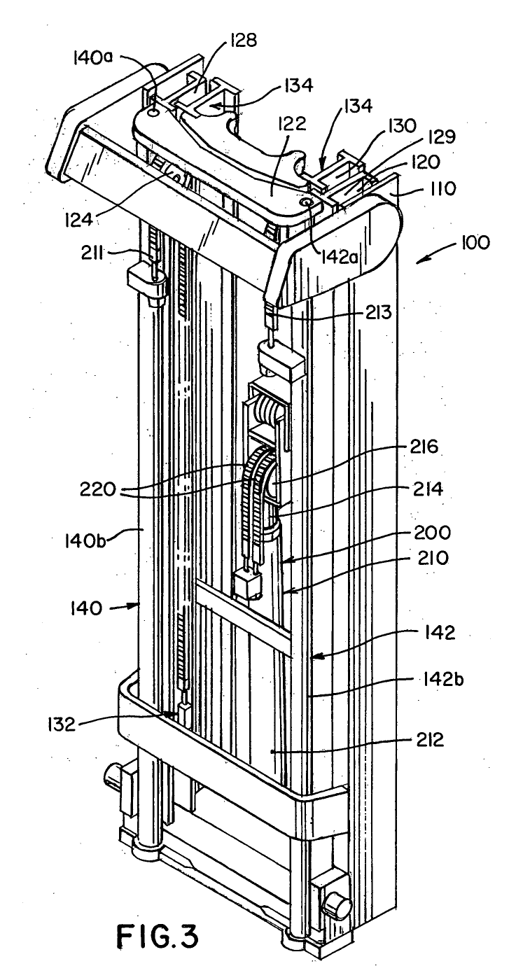

Reference is now made to FIG. 1, which is a perspective view of a three-wheel stand-up counterbalanced fork lift truck 10. A mast assembly 100, a fork carriage assembly 150 and a fork carriage assembly lift unit 200, constructed in accordance with a first embodiment of the present invention, are incorporated into the truck 10, see also FIGS. 2 and 3. While the present invention is described herein with reference to the stand-up counterbalanced truck 10, it will be apparent to those skilled in the art that the invention and variations of the invention can be more generally applied to a variety of other materials handling vehicles.

The fork lift truck 10 further includes a main body or base 12 comprising a frame 14, first and second driven wheels coupled to a front portion of the frame 14, only the first wheel 16 is illustrated in FIG. 1, and a third steerable wheel 18 coupled to a rear portion of the frame 14. The first, second and third wheels 16 and 18 allow the truck 10 to move across a floor surface.

A rider compartment 30 is located within the main body frame 14 for receiving an operator. The speed and direction of movement (forward or reverse) of the truck 10 can be controlled by the operator via a multifunction controller (MFC). Steering is effected via a tiller 116A.

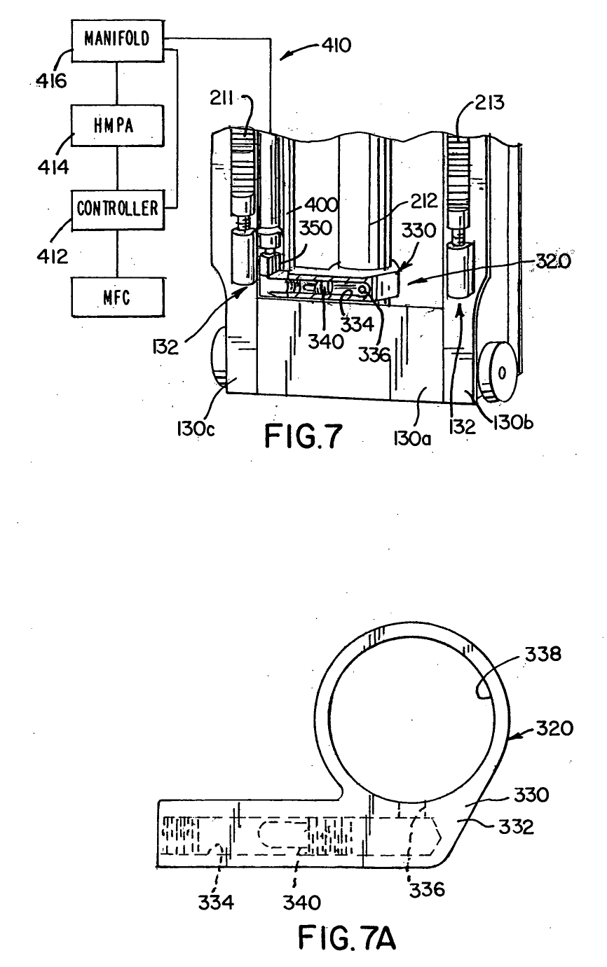

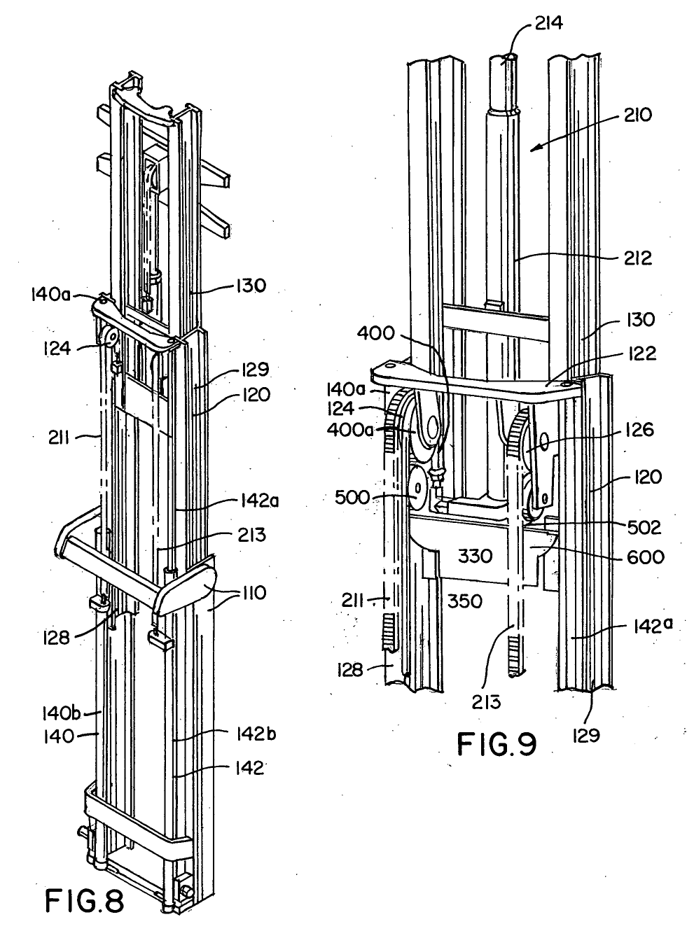

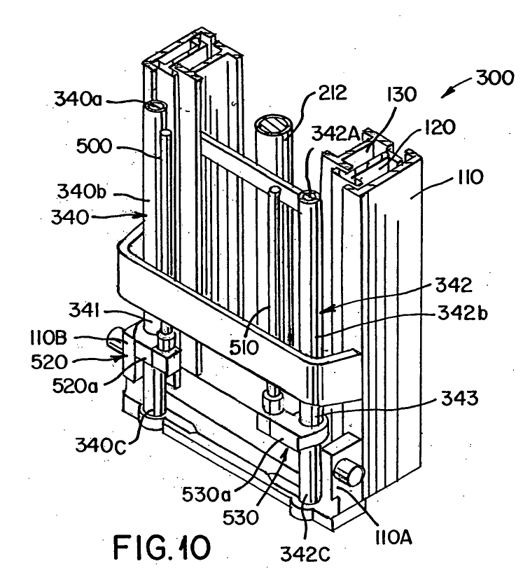

The mast assembly 100 includes first, second and third mast weldments 110, 120 and 130, see FIGS. 2 and 3, where the second weldment 120 is nested within the first weldment 110 and the third weldment 130 is nested within the second weldment 120. The first weldment 110 is fixed to the truck main body frame 14. The second or intermediate weldment 120 is capable of vertical movement relative to the first weldment 110. The third or inner weldment 130 is capable of vertical movement relative to the first and second weldments 110 and 120. First and second lift ram/cylinder assemblies 140 and 142 are fixed at their cylinders 140b and 142b to the first weldment 110, see FIG. 3. Rams 140a and 142a extending from the cylinders 140b and 142b are fixed to an upper brace 122 of the second weldment 120, see FIG. 3. First and second pulleys 124 and 126 are fixed to either the second weldment upper brace 122, see FIGS. 8 and 9, or upper portions of vertical rails 128 and 129 of the second weldment 120. A first chain 211 is fixed to the cylinder 140b of the first ram/cylinder assembly 140 and a second chain 213 is fixed to the cylinder 142b of the second ram/cylinder assembly 142, see FIGS. 3 and 8. The first chain 211 extends over the first pulley 124 and is coupled to a lower portion 132 of the third weldment 130, see FIGS. 3 and 7. The second chain 213 extends over the second pulley 126 and is also coupled to the third weldment lower portion 132, see FIG. 7. The third weldment lower portion 132 may comprise lower portions of vertical rails 130b and 130c, see FIG. 7, or a lower brace or plate 130a extending between lower portions of the vertical rails 130b and 130c of the third weldment 130. In FIG. 9, a hydraulic fluid hose guide plate 600 is provided in front of the plate 130a. In FIG. 7, the guide plate 600 has been removed to allow plate 130a to be visible. When the rams 140a and 142a of the assemblies 140 and 142 are extended, the rams 140a and 142a lift the second weldment 120 vertically relative to the fixed first weldment 110. Further, the first and second pulleys 124 and 126 fixed to upper portions of the second weldment 120 apply upward forces on the chains 211 and 213 causing the third weldment 130 to move vertically relative to the first and second weldments 110 and 120. For every one unit of vertical movement of the second weldment 120, the third weldment 130 moves vertically two units, see FIG. 8.

The fork carriage assembly 150 comprises a pair of forks 152 and a fork carriage 154 upon which the forks 152 are mounted, see FIGS. 1 and 2 (the fork carriage assembly 150 is not illustrated in FIG. 3). The fork carriage 154 is provided with first and second pairs of rollers (not shown), which rollers are received in inner tracks 134 of the third weldment 130, see FIG. 3. The pairs of rollers allow the fork carriage 154 to move vertically up and down relative to the third weldment 130.

The fork carriage assembly lift unit 200 is coupled to the third weldment 130 and the fork carriage assembly 150 to effect vertical movement of the fork carriage assembly 150 relative to the third weldment 130. The lift unit 200 includes a ram/cylinder assembly 210 comprising a cylinder 212 fixed to a bracket 135, which, in turn, is fixed to the brace or plate 130a of the third weldment 130, such that it moves with the third weldment 130, see FIG. 6. A ram 214 is associated with the cylinder 212 and is capable of extending from the cylinder 212 when pressurized hydraulic fluid is provided to the cylinder 212, see FIGS. 3-5. The ram 214 is lifted from the cylinder 212 so long as pressurized hydraulic fluid enters the cylinder 212 at a location between a cylinder base 212c and a cylinder seal 212d provided at an end of the cylinder 212 opposite the cylinder base 212c. In the FIG. 5 embodiment, the seal 212d is coupled to an inner wall of the cylinder 212. In another embodiment discussed below, the seal is attached to the ram.

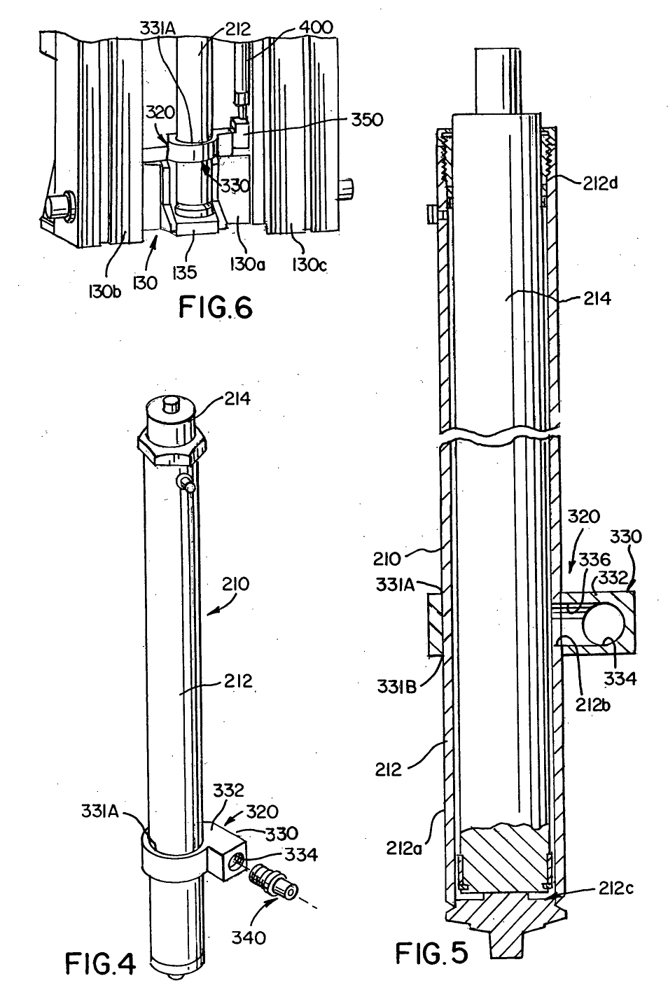

A pulley 216 is coupled to an upper end of the ram 214, see FIG. 3 (the pulley 216 is not shown in FIGS. 4 and 5). A pair of lift chains 220 are fixed at one end to the cylinder 212, extend over the pulley 216 and are coupled to a lower portion 154a of the fork carriage 154, see FIGS. 2 and 3. When pressurized fluid is provided to the cylinder 212, the ram 214 is extended causing the pulley 216 to move vertically relative to the third weldment 130. Vertical movement of the pulley 216 causes the lift chains 220 to raise the fork carriage assembly 150 relative to the third weldment 130.

The ram/cylinder assembly 210 includes coupling structure 320 for coupling a hydraulic fluid supply hose 400 to the cylinder 212, see FIGS. 4-7. The hose 400 forms part of a fluid supply system 410, which may further comprise a controller 412, a hydraulic motor/pump assembly 414 and a manifold 416, see FIG. 7. The fluid supply system 410 comprises part of the lift unit 200. Operator commands for controlling the ram/cylinder assembly 210 and, hence, the vertical position of the fork carriage assembly 150 relative to the third weldment 130, are input by an operator via the multifunction controller MFC. The multifunction controller MFC provides electronic command signals to the controller 412, which, in turn, generates electronic control signals to the hydraulic motor/pump assembly 414 and one or more electronically controlled valves provided in the manifold 416, such that pressurized hydraulic fluid is provided to or released from the ram/cylinder assembly 210 via the coupling structure 320.

In the illustrated embodiment, the coupling structure 320 comprises a collar 330 welded or otherwise connected to an outer side wall 212a of the cylinder 212, see FIG. 5. The cylinder sidewall 212a includes an opening 212b through which hydraulic fluid enters and exits the cylinder 212. The collar 330 may comprise a metal housing 332 having a first bore 334 and a second bore 336 extending from the first bore 334 to a center opening 338 of the collar 330, see FIG. 7A. The second bore 336 is located so as to communicate with the cylinder sidewall opening 212b, see FIG. 5. The center opening 338 is provided for receiving the cylinder 212. Once the collar 330 is fitted over the cylinder 212 and properly adjusted such that the second bore 336 is in line with the cylinder sidewall opening 212b, the collar 330 is welded or otherwise coupled to the cylinder 212 such as by welding the collar 330 to the cylinder 212 at upper and lower circumferential weld locations 331A and 331B to seal the collar 330 to the cylinder 212.

The first bore 334 may be threaded for receiving a mechanical flow control valve 340, see FIGS. 4, 7 and 7A (the valve is not shown in FIG. 5). The flow control valve 340 may comprise a restrictor, a velocity fuse or a like element. For example, a restrictor functions to limit the rate at which hydraulic fluid exits the cylinder 212 so as to prevent an unintended descent of the fork carriage assembly 150. A velocity fuse has a fixed setpoint such that it closes and stops fluid flow when the carriage assembly downward speed exceeds a threshold value.

A conventional fitting 350 is coupled to the fluid supply hose 400 and threadedly received in the collar first bore 334 so as to permit fluid from the hose 400 to enter and exit the collar 330, see FIG. 7. The fluid supply hose 400, when coupled by the fitting 350 to the collar 330, is under tension. Hence, the collar 330 also functions an anchor block as the collar 330 has sufficient rigidity to support the hose 400 when under tension. The hose 400 is placed under tension for aesthetic reasons as well as to ensure that the hose 400 remains on a pulley 400a (shown in FIG. 9) coupled to the second weldment 120 and positioned adjacent to the pulley 124.

In the illustrated embodiment, the collar 330 is mounted above the lower brace or plate 130a extending between lower portions of the vertical rails 130b and 130c of the third weldment 130, see FIG. 7. By placing the collar 330 above the plate 130a, connection of the supply hose 400 via the fitting 350 to the collar 330 during vehicle assembly in manufacturing or servicing in the field may be effected more easily as a technician is provided with more room in which to manipulate his hands and/or the hose 400 and fitting 350 since the point of connection between the fitting 350 and the collar 330 is located above the plate 130a. However, it is also contemplated that plate 130a may be positioned above or in-line with the collar 330. For example, the plate 130a may be raised from its position illustrated in FIG. 6, while the collar 330 remains substantially in the position illustrated. The bracket 135 remains coupled to the plate 130a but includes structure allowing it to extend downward from the plate 130a such that the base of the cylinder 212 remains in substantially the same position illustrated in FIG. 6. Hence, in this embodiment, the collar 330 remains positioned above the base 212c of the cylinder 212.

As illustrated in FIG. 9, third and fourth pulleys 500 and 502 (not shown in FIG. 8) may also be mounted to the upper portion of the second weldment 120. One or more additional hydraulic fluid hoses (not shown) may pass over the third and fourth pulleys 500 and 502 and extend to one or more devices (not shown) supported by the fork carriage assembly 150, wherein the one or more devices may comprise a carton clamp, a fork side shift device, a fork reach mechanism, a paper roll clamp, a slip sheet device or like devices. Preferably, the collar 330 is positioned on the cylinder 212 so as to be located below the first, second, third and fourth pulleys 124, 126, 500 and 502 as well as pulley 400a when the third weldment 130 is extended to its outer-most position relative to the second weldment 120, see FIG. 9. Hence, the collar 330 does not engage the pulleys 124, 126, 400a, 500 and 502 or chains/hoses associated with the pulleys 124, 126, 400a, 500, 502. The first, second, third and fourth pulleys 124, 126, 500 and 502 and hose pulley 400a are also referred to herein as guide elements.

While the mast assembly 100 of the illustrated embodiment comprises first, second and third weldments, it is contemplated that the mast assembly may comprise a single weldment, two weldments or four or more weldments.

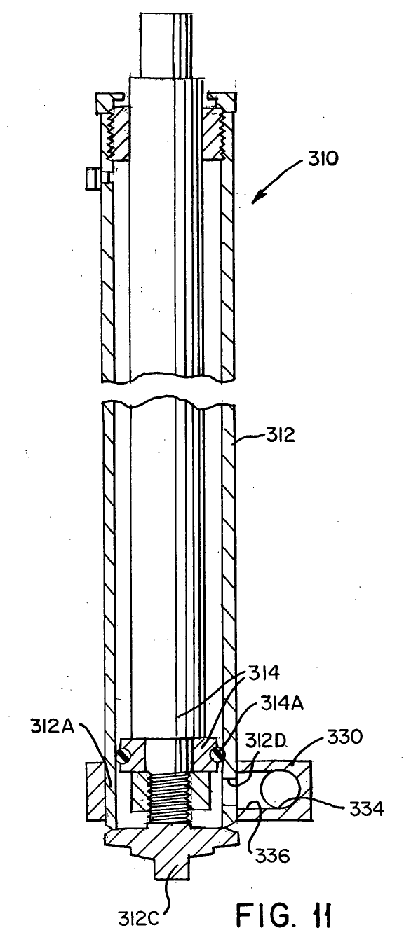

A portion of a mast assembly 300 constructed in accordance with a second embodiment of the present invention is illustrated in FIG. 10, where like reference numerals indicate like elements. The mast assembly 300 includes first, second and third fork weldments 110, 120 and 130, which are constructed in the same manner as the first, second and third weldments illustrated in FIGS. 2 and 3. First and second lift ram/cylinder assemblies 340 and 342 are fixed at their cylinders 340b and 342b to the first weldment 110, see FIG. 10. Rams 340a and 342a extend from the cylinders 340b and 342b and, just as the rams 140a and 142a in the embodiment illustrated in FIG. 3, are fixed to the upper brace 122 of the second weldment 120.

The ram/cylinder assemblies 340 and 342 are similar in construction to the ram/cylinder assembly 210 illustrated in FIGS. 4 and 5. Hence, the ram 340a is extended when pressurized hydraulic fluid is provided to the cylinder 340b at a location between a cylinder base 340c and a cylinder seal (not shown) provided at an end (not shown) of the cylinder 340b opposite the cylinder base 340c. Likewise, the ram 342a is extended when pressurized hydraulic fluid is provided to the cylinder 342b at a location between a cylinder base 342c and a cylinder seal (not shown) provided at an end (not shown) of the cylinder 342b opposite the cylinder base 342c.

The ram/cylinder assembly 340 includes first coupling structure 520 for coupling a hydraulic fluid supply hose 500 to the cylinder 340b, see FIG. 10. Likewise, the ram/cylinder assembly 342 includes second coupling structure 530 for coupling a hydraulic fluid supply hose 510 to the cylinder 342b. The fluid supply hoses 500 and 510 form part of the fluid supply system 410. Operator commands for controlling the ram/cylinder assemblies 340 and 342 and, hence, the vertical position of the second and third weldments 120 and 130 relative to the first weldment 110, are input by an operator via the multifunction controller MFC.

In the illustrated embodiment, the first coupling structure 520 comprises a collar 520a welded or otherwise connected to an outer side wall 341 of the cylinder 340b. Likewise, the second coupling structure 530 comprises a collar 530a welded or otherwise connected to an outer side wall 343 of the cylinder 342b. The collars 520a and 530a are constructed in essentially the same manner as the collar 330 illustrated in FIGS. 5-7 and 7A. Further, each collar 520a and 530a may be provided with a flow control valve in a bore in the collar. In the illustrated embodiment, the collars 520a and 530a are positioned on the cylinders 340b and 342b so as to be spaced above lower side blocks 110A and 110B forming part of the first weldment 110, see FIG. 10.

It is still further contemplated that the collar 330 may be coupled to a lower end 312A of a cylinder 312 of a ram/cylinder assembly 310, where the ram 314 is provided with a seal 314A at its lower end, see FIG. 11, where like reference numerals indicate like elements. Hence, in this embodiment, the seal 314A is not provided on the cylinder inner wall at an end of the cylinder opposite the cylinder base 312c. The collar 330 is positioned on the cylinder 312 such that the second bore 336 is below the seal 314A when the ram 314 is in its lowermost position in the cylinder 312, i.e., the collar second bore 336 is always positioned between the seal 314A and the cylinder base 312c. The second bore 336 communicates with a cylinder sidewall opening 312A.

It is also contemplated that the collar of the present invention may be used at opposing ends of a cylinder of a double-acting ram/cylinder assembly.

It is also contemplated that a collar constructed in accordance with the present invention may be coupled to a sidewall of one or more single-acting ram/cylinder assemblies in other materials handling vehicles, such as pallet trucks, reach trucks, stockpicker trucks, turret trucks, stacker trucks and like trucks.

The definitions of the words or elements of the following claims shall include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim.

Insubstantial changes from the claimed subject matter as viewed by a person with ordinary skill in the art, now known or later devised, are expressly contemplated as being equivalently within the scope of the claims.

The claims are thus to be understood to include what is specifically illustrated and described above, what is conceptually equivalent, what can be obviously substituted and also what essentially incorporates the essential idea of the invention.

What is claimed is:

1. A materials handling vehicle comprising:
a base;
a movable element;
a ram/cylinder assembly coupled to said movable element to effect movement of said element comprising a cylinder having an opening in a side wall for receiving a fluid, a ram disposed in said cylinder and coupling structure connected to said cylinder side wall including a bore communicating with said cylinder side wall opening; and
a fluid supply system including a fluid hose connected to said coupling structure for supplying pressurized fluid to said coupling structure to effect movement of said ram in said cylinder, wherein movement of said ram causes movement of said movable element.

2. A materials handling vehicle as set forth in claim 1, wherein said coupling structure is positioned on said cylinder side wall at a location above a base of said ram.

3. A materials handling vehicle as set forth in claim 1, wherein said ram/cylinder assembly is coupled to a mast weldment having first and second vertical frame members and upper and lower braces, said coupling structure being positioned on said cylinder side wall at a location above said mast weldment lower brace.

4. A materials handling vehicle as set forth in claim 3, wherein a base of said cylinder is supported by a bracket coupled to said lower brace.

5. A materials handling vehicle as set forth in claim 1, wherein said coupling structure comprises a collar connected to said cylinder side wall and including a bore communicating with said cylinder side wall opening.

6. A materials handling vehicle as set forth in claim 5, further comprising a flow control valve provided in said bore in said collar.

7. A materials handling vehicle as set forth in claim 5, wherein said collar has sufficient rigidity to function as an anchor block for said fluid hose.

8. A materials handling vehicle as set forth in claim 1, wherein said movable element comprises a movable weldment of a mast assembly.

9. A materials handling vehicle as set forth in claim 1, wherein said movable element comprises a movable carriage assembly.

10. A materials handling vehicle as set forth in claim 9, wherein said carriage assembly comprises a fork carriage assembly.

11. A materials handling vehicle as set forth in claim 1, wherein said ram/cylinder assembly further comprises a seal coupled to one of said ram and an inner wall of said cylinder.

12. A materials handling vehicle comprising:
a base;
a mast assembly coupled to said base;
a fork carriage assembly coupled and movable relative to said mast assembly;
a ram/cylinder assembly coupled to said fork carriage assembly and said mast assembly to effect movement of said fork carriage assembly relative to said mast assembly comprising a cylinder having an opening in a side wall for receiving a fluid, a ram disposed in said cylinder and coupling structure connected to said cylinder side wall, said coupling structure including a bore communicating with said cylinder side wall opening; and
fluid supply system including a fluid hose connected to said coupling structure for supplying pressurized fluid to said coupling structure to effect movement of said ram in said cylinder, wherein movement of said ram causes movement of said fork carriage assembly.

13. A materials handling vehicle as set forth in claim 12, wherein said coupling structure comprises a collar connected to said cylinder side wall and including a bore communicating with said cylinder side wall opening.

14. A materials handling vehicle as set forth in claim 13, wherein said collar is positioned on said cylinder side wall at a location above a base of said ram.

15. A materials handling vehicle as set forth in claim 13, wherein said ram/cylinder assembly is coupled to a mast weldment forming part of said mast assembly having first and second vertical frame members and upper and lower braces, said collar being positioned on said cylinder side wall at a location above said mast weldment lower brace.

16. A materials handling vehicle as set forth in claim 15, wherein a base of said cylinder is supported by a bracket coupled to said lower brace.

17. A materials handling vehicle as set forth in claim 13, further comprising a flow control valve provided in said bore in said collar.

18. A materials handling vehicle as set forth in claim 13, wherein said collar has sufficient rigidity to function as an anchor block for said fluid hose.

19. A materials handling vehicle as set forth in claim 13, wherein said mast assembly comprises:
an outer weldment coupled to said base;
an intermediate weldment capable of moving in a direction away from said base such that a lower end of said intermediate weldment is positioned adjacent an upper end of said outer weldment;
an inner weldment capable of moving in a direction away from said base such that a lower end of said inner weldment is positioned adjacent an upper end of said intermediate weldment, said carriage assembly being coupled to said inner weldment; and
said intermediate weldment including at least one guide element mounted adjacent its upper end, said collar being connected to said cylinder at a location such that said collar does not engage said intermediate weldment guide element when said inner weldment is moved to a position where its lower end is positioned adjacent said upper end of said intermediate weldment.
